(19) United States
(12) Patent Application Publication
(10) Pub. No.: US 2018/0189272 A1
(43) Pub. Date: Jul. 5, 2018

(54) APPARATUS AND METHOD FOR SENTENCE ABSTRACTION

(71) Applicant: NCSOFT Corporation, Seoul (KR)

(72) Inventors: Hyung Jong Noh, Seongnam-si (KR); Yeon Soo Lee, Seongnam-si (KR); Jun Yeop Lee, Seongnam-si (KR); Jung Sun Jang, Seongnam-si (KR)

(21) Appl. No.: 15/851,628

(22) Filed: Dec. 21, 2017

(30) Foreign Application Priority Data
Dec. 29, 2016 (KR) 10-2016-0182291

(51) Int. Cl. G06F 17/27; G06N 3/04; G06N 3/08

(52) U.S. Cl. CPC G06F 17/2785; G06N 3/08; G06N 3/0445

(57) ABSTRACT

Disclosed are an apparatus and method for sentence abstraction. According to one embodiment of the present disclosure, the method for abstracting a sentence includes receiving a plurality of sentences including natural language; generating a sentence vector for each of the plurality of sentences by using a recurrent neural network model; grouping the plurality of sentences into one or more clusters by using the sentence vector; and generating the same sentence ID for sentences grouped into the same cluster among the plurality of sentences.

### CROSS-REFERENCE TO RELATED APPLICATION

This application claims priority to and the benefit of Korean Patent Application No. 10-2016-0182291, filed on Dec. 29, 2016, the disclosure of which is incorporated herein by reference in its entirety.

### BACKGROUND

### 1. Field

Embodiments of the present disclosure relate to a technology for converting a natural language sentence into an abstracted expression.

### 2. Discussion of Related Art

Natural language generation (NLG) technology generates natural language that can be understood by a human from various pieces of data through a computer.

A conventional document generation method using the natural language generation technology generally determines which sentences are arranged in which order, and generates and arranges actual sentences in accordance with the determined order. Although such a procedure is generally performed on the basis of preset rules, it is very difficult to generate rules for all cases, and much time and labor are also needed to check for an error in the generated rules.

### SUMMARY

The present disclosure is directed to an apparatus and method for sentence abstraction.

According to an aspect of the present disclosure, there is provided a method for abstracting a sentence performed in a computing device including one or more processors and a memory configured to store one or more programs to be executed by the one or more processors, the method including: receiving a plurality of sentences comprising natural language; generating a sentence vector for each of the plurality of sentences by using a recurrent neural network model; grouping the plurality of sentences into one or more clusters by using the sentence vector; and generating the same sentence identification (ID) for sentences grouped into the same cluster among the plurality of sentences.

The recurrent neural network model may include a recurrent neural network model of an encoder-decoder structure including an encoder for generating a hidden state vector from an input sentence and a decoder for generating a sentence corresponding to the input sentence from the hidden state vector.

The sentence vector may include a hidden state vector for each of a plurality of sentences generated by the encoder.

The recurrent neural network model may use a latent short term memory (LSTM) unit or a gated recurrent unit (GRU) as a hidden layer unit.

The grouping may include an operation of grouping the plurality of sentences into one or more clusters based on a similarity between the sentence vectors for each of the plurality of sentences.

According to another aspect of the present disclosure, there is provided an apparatus for abstracting a sentence, the apparatus including: an inputter configured to receive a plurality of sentences including a natural language; a sentence vector generator configured to generate a sentence vector for each of the plurality of sentences by using a recurrent neural network model; a clusterer configured to group the plurality of sentences into one or more clusters by using the sentence vector; and an ID generator configured to generate same sentence ID for sentences grouped into the same cluster among the plurality of sentences.

The recurrent neural network model may include a recurrent neural network model of an encoder-decoder structure including an encoder for generating a hidden state vector from an input sentence and a decoder for generating a sentence corresponding to the input sentence from the hidden state vector.

The sentence vector may include a hidden state vector for each of a plurality of sentences generated by the encoder.

The recurrent neural network model may use an LSTM unit or a GRU as a hidden layer unit.

The clusterer may be configured to group the plurality of sentences into one or more clusters based on a similarity between the sentence vectors for each of the plurality of sentences.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a diagram of a sentence abstraction apparatus according to one embodiment of the present disclosure;

FIG. 2 is a diagram showing a procedure of generating a sentence vector using a recurrent neural network model of an encoder-decoder structure according to one embodiment of the present disclosure;

FIG. 3 is a diagram of an example of sentence identification (ID) generation according to one embodiment of the present disclosure;

FIG. 4 is a flowchart of a sentence abstraction method according to one embodiment of the present disclosure; and

FIG. 5 is a block diagram for exemplifying and describing a computing environment including a computing device suitable for use in exemplified embodiments of the present disclosure.

### DETAILED DESCRIPTION OF EXEMPLARY EMBODIMENTS

Embodiments of the present disclosure will be described below with reference to the accompanying drawings. The detailed descriptions set forth herein are provided for a better comprehensive understanding of a method, apparatus and/or system described in this specification. However, these descriptions are merely examples and are not to be construed as limiting the present disclosure.

In descriptions of the embodiments of the present disclosure, detailed descriptions about a publicly known art related to the present disclosure will be omitted when it is determined that the detailed descriptions obscure the gist of the present disclosure. Further, terms used herein, which are defined by taking the functions of the present disclosure into account, may vary depending on users, an intention or convention of an operator, and the like. Therefore, the definition should be based on the content given throughout the specification. The terms in the detailed descriptions are used only for describing the embodiments of the present disclosure and are not restrictively used. Unless otherwise indicated, terms having a singular form also have a plural meaning. In the present disclosure, expressions such as “include” or “have” indicate the inclusion of certain features, numerals, operations, operations, elements, or a combination thereof, and are not to be construed as excluding the presence or possibility of one or more other certain features, numerals, operations, operations, elements, or a combination thereof.

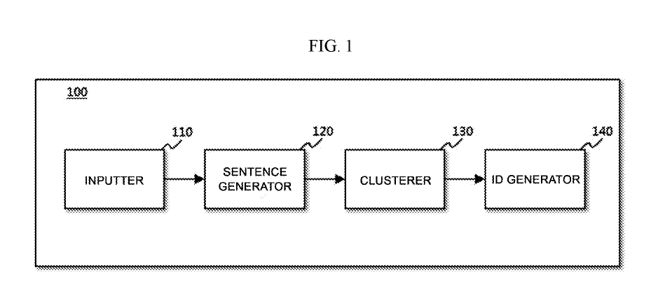

FIG. 1 is a diagram of a sentence abstraction apparatus according to one embodiment of the present disclosure.

Referring to FIG. 1, the sentence abstraction apparatus according to one embodiment of the present disclosure includes an inputter 110, a sentence vector generator 120, a clusterer 130, and an identification (ID) generator 140.

The inputter 110 receives a plurality of natural language sentences.

The sentence vector generator 120 generates sentence vectors for the input sentences through a recurrent neural network model.

In this case, according to one embodiment of the present disclosure, the recurrent neural network model may be a recurrent neural network model of an encoder-decoder structure which includes an encoder for generating a hidden state vector having a fixed length by receiving one sentence, and a decoder for generating a sentence from the generated hidden state vector.

Specifically, the sentence vector generator 120 may use the encoder of the recurrent neural network model to generate a hidden state vector for each of the input sentences and use the generated hidden state vector as the sentence vector for each of the sentences.

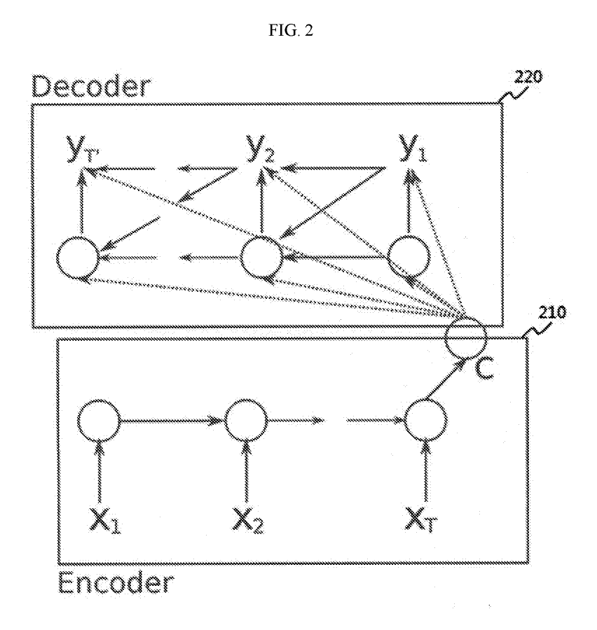

FIG. 2 is a diagram showing a procedure of generating a sentence vector using a recurrent neural network model of an encoder-decoder structure according to one embodiment of the present disclosure;

Referring to FIG. 2, the recurrent neural network model according to one embodiment of the present disclosure may include an encoder 210 for converting the words included in the input sentence into embedding vectors X₁, X₂, and X_{T} of a preset dimension and converting the converted embedding vectors X₁, X₂, and X_{T} into a hidden state vector C, and a decoder 220 for generating embedding vectors Y₁, Y₂, and Y_{T′} of a preset dimension which correspond to specific words from the hidden state vector C.

Meanwhile, the sentence vector generator 120 may generate the hidden state vector C for each sentence input to the inputter 110 using the encoder 210 of the recurrent neural network model, and this hidden state vector C corresponds to a sentence vector for each of the sentences.

Meanwhile, according to one embodiment of the present disclosure, the recurrent neural network model may be learned using a plurality of previously collected sentences. In this case, for example, training data in which the same two sentences are used as an input and output pair may be employed for the learning, but the training data is not limited thereto. Alternatively, training data in which two sentences having the same meaning (for example, a Korean sentence and an English sentence which have the same meaning or two sentences which have the same content but are different in narrative form) are used as the input and output pair may be employed.

Meanwhile, according to one embodiment of the present disclosure, the recurrent neural network model may be a recurrent neural network model which employs a latent short term memory (LSTM) unit or a gated recurrent unit (GRU) as a hidden layer unit of the encoder 210 and the decoder 220 of the recurrent neural network.

The clusterer 130 groups the input sentences into one or more clusters by using the sentence vector generated in the sentence vector generator 120.

Specifically, according to one embodiment of the present disclosure, the clusterer 130 may group the input sentences into one or more clusters based on similarity between the sentence vectors.

For example, the clusterer 130 may employ a K-mean clustering algorithm based on cosine similarity between the sentence vectors to group the input sentences into k clusters.

Alternatively, the clusterer 130 may employ an incremental clustering method, in which the number of clusters to be grouped is not set, to group the input sentences into one or more clusters.

Meanwhile, the clustering method for the input sentences is not absolutely limited to the above examples and various clustering methods may be employed besides the K-mean clustering method and the incremental clustering method.

The ID generator 140 may generate the same sentence ID for sentences grouped into the same cluster.

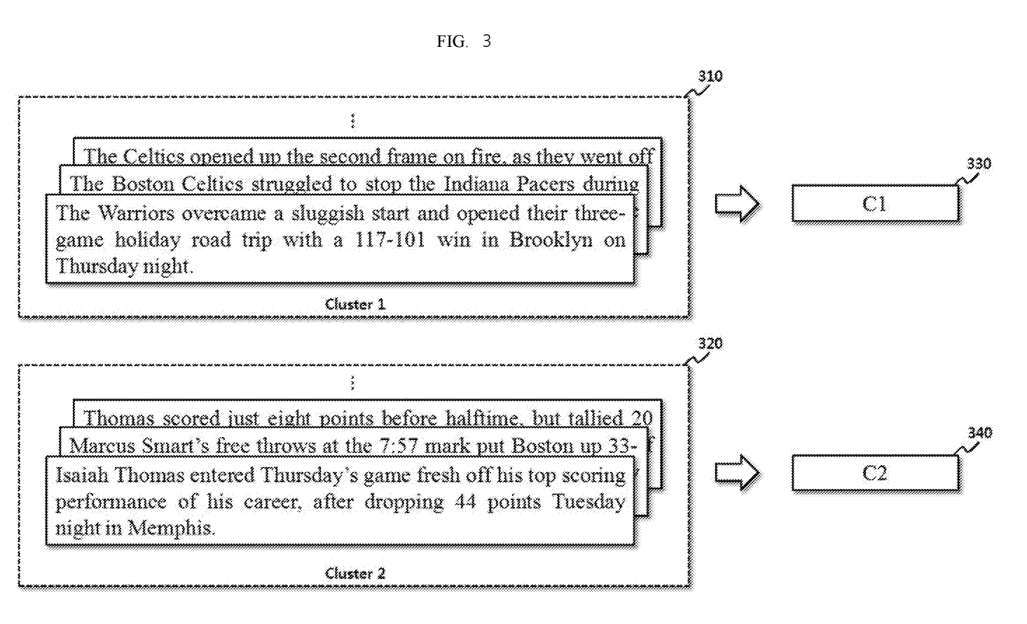

Specifically, FIG. 3 is a diagram of an example of sentence ID generation according to one embodiment of the present disclosure.

As shown in FIG. 3, when it is assumed that the input sentences are grouped into two clusters 310 and 320 by the clusterer 130, the ID generator 140 may generate the same sentence IDs 330 and 340 for the sentences included in the clusters.

That is, as shown therein, the sentence ID ‘C1’ 330 may be generated for the sentences grouped into ‘Cluster 1’ 310, and the sentence ID ‘C2’ 340 may be generated for the sentences grouped into ‘Cluster 2’ 320.

Meanwhile, according to one embodiment of the present disclosure, the method of generating a sentence ID is not limited to a specific method, and various methods such as a method of generating a sentence ID with arbitrary text, a method of assigning one of previously generated sentence IDs, a method of generating a sentence ID based on words extracted from sentences included in each cluster, and the like may be used.

Meanwhile, according to one embodiment, the sentence abstraction apparatus 100 shown in FIG. 1 may be implemented in a computing device that includes at least one processor and a computer readable recording medium connected to the processor. The computer readable recording medium may be internally or externally provided in the processor and connected to the processor by various well-known means. The processor in the computing device may make each computing device operate according to exemplified embodiments described in this specification. For example, the processor may execute an instruction stored in the computer readable recording medium, and the instruction stored in the computer readable recording medium may be configured to make the computing device operate according to the exemplified embodiments described in this specification when executed by the processor.

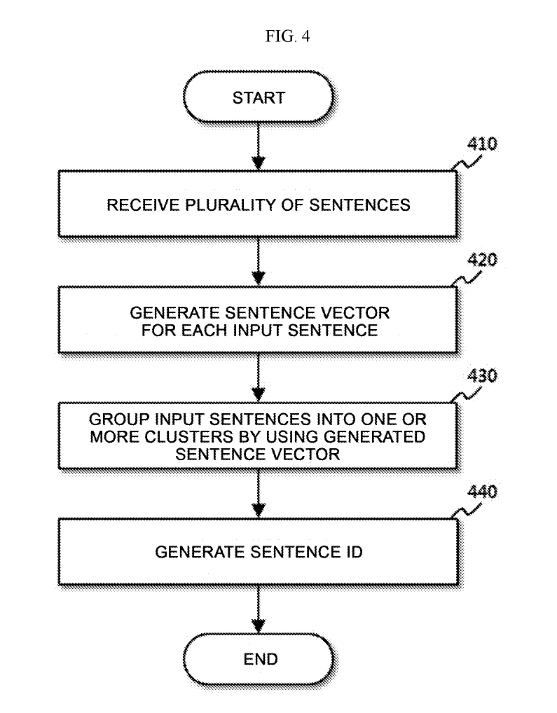

FIG. 4 is a flowchart of a sentence abstraction method according to one embodiment of the present disclosure.

For example, the method shown in FIG. 4 may be implemented by the sentence abstraction apparatus 100 shown in FIG. 1.

Meanwhile, the flowchart of FIG. 4 shows the method being divided into a plurality of operations, and at least some of the operations may be reordered, performed in combination with another operation, omitted, divided into sub operations, or performed with one or more added operations (not shown).

Referring to FIG. 4, first, the sentence abstraction apparatus 100 receives a plurality of input natural language sentences (410).

Then, the sentence abstraction apparatus 100 generates a sentence vector for each of the input sentences by using a recurrent neural network model (420).

In this case, according to one embodiment of the present disclosure, the recurrent neural network model may be a recurrent neural network model of an encoder-decoder structure which includes an encoder for generating a hidden state vector having a fixed length by receiving one sentence, and a decoder for generating a sentence from the generated hidden state vector.

Specifically, the sentence abstraction apparatus 100 may use the encoder of the recurrent neural network model to generate a hidden state vector for each of the input sentences and use the generated hidden state vector as the sentence vector for each of the sentences.

Further, according to one embodiment of the present disclosure, the recurrent neural network model may be a recurrent neural network model that employs an LSTM unit or a GRU as the hidden layer unit for the encoder and the decoder of the recurrent neural network.

Then, the sentence abstraction apparatus 100 groups the input sentences into one or more clusters by using the generated sentence vector (430).

In this case, according to one embodiment of the present disclosure, the sentence abstraction apparatus 100 may group the input sentences into one or more clusters based on similarity between the sentence vectors.

Then, the sentence abstraction apparatus 100 generates the same sentence ID for the sentences grouped into the same cluster (440).

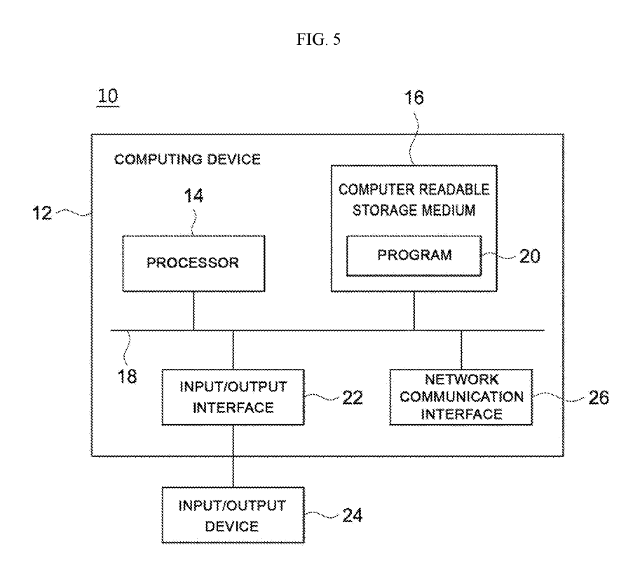

FIG. 5 is a block diagram for exemplifying and describing a computing environment including a computing device suitable for use in exemplified embodiments of the present disclosure. In the shown embodiments, components may have functions and abilities different from those of the following descriptions, and other components may be present in addition to those described below.

A computing environment 10 shown in FIG. 5 includes a computing device 12. According to one embodiment, the computing device 12 may include the sentence abstraction apparatus 100 according to the embodiments of the present disclosure. The computing device 12 includes at least one processor 14, a computer readable storage medium 16, and a communication bus 18. The processor 14 may make the computing device 12 operate according to the above-mentioned exemplified embodiments. For example, the processor 14 may execute one or more programs stored in the computer readable storage medium 16. The one or more programs may include one or more computer executable instructions, and the computer executable instruction may be configured to make the computing device 12 operate according to the exemplified embodiments when executed by the processor 14.

The computer readable storage medium 16 is configured to store a computer executable instruction or program code, program data, and/or information having other suitable forms. A program 20 stored in the computer readable storage medium 16 includes an instruction set executable by the processor 14. According to one embodiment, the computer readable storage medium 16 may include a memory (i.e. a volatile memory such as a random access memory (RAM), a nonvolatile memory, or a proper combination thereof), one or more magnetic disk storage devices, optical disk storage devices, flash memory devices, other storage media accessed by the computing device 12 and capable of storing desired information, or a proper combination thereof.

The communication bus 18 connects various components of the computing device 12, such as the processor 14 and the computer readable storage medium 16, with each other.

The computing device 12 may also include one or more input/output interfaces 22 providing interfaces for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. An exemplified input/output device 24 may include an input device such as a pointing device (e.g. a mouse, a trackpad, and the like), a keyboard, a touch input device (e.g. a touch pad, a touch screen, and the like), a voice or sound input device, various kinds of sensing devices, and/or a photographing device, and/or an output device such as a display device, a printer, a loudspeaker, and/or a network card. The exemplified input/output device 24 may be internally provided in the computing device 12 as a component of the computing device 12, or may be provided separately from the computing device 12 and connected to the computing device 12.

Meanwhile, one embodiment of the present disclosure may include a computer readable recording medium including a program to implement the methods described in this specification on a computer. The computer readable recording medium may include a single or combination of a program command, a local data file, a local data structure, and the like. The medium may be specially designed and configured for the present disclosure, or may be typically available in the computer software field. The computer readable recording medium may include, for example, a magnetic medium such as a hard disk, a floppy disk, and a magnetic tape; an optical recording medium such as a compact disc read-only memory (CD-ROM) and a digital versatile disc (DVD); a magnetic-optical medium such as a floppy disk; and a hardware device specially configured to store and execute a program command, such as a ROM, a RAM, a flash memory, and the like. The program command may include, for example, not only a machine language code produced by a compiler, but also a high-level language code to be executable by a computer through an interpreter or the like.

According to embodiments of the present disclosure, it is possible to express the same or similar natural language sentences in an abstracted form using the same ID and express a paragraph or document including one or more sentences as an ID sequence of sentences included in each paragraph or document, and this may be used as training data for learning of a deep learning based model for determining an arrangement of sentences that will constitute a document or paragraph when a document including the natural language sentences is generated.

Although exemplary embodiments of the present disclosure have been described in detail, it should be appreciated by a person having ordinary skill in the art that various changes may be made to the above exemplary embodiments without departing from the scope of the present disclosure, and the scope is not limited to the above embodiments but defined in the following claims and their equivalents.

What is claimed is:

1. A method for abstracting a sentence performed in a computing device comprising one or more processors and a memory configured to store one or more programs to be executed by the one or more processors, the method comprising:
receiving a plurality of sentences comprising natural language;
generating a sentence vector for each of the plurality of sentences by using a recurrent neural network model;
grouping the plurality of sentences into one or more clusters by using the sentence vector; and
generating the same sentence identification (ID) for sentences grouped into the same cluster among the plurality of sentences.

2. The method of claim 1, wherein the recurrent neural network model comprises a recurrent neural network model of an encoder-decoder structure comprising an encoder for generating a hidden state vector from an input sentence and a decoder for generating a sentence corresponding to the input sentence from the hidden state vector.

3. The method of claim 2, wherein the sentence vector comprises a hidden state vector for each of a plurality of sentences generated by the encoder.

4. The method of claim 2, wherein the recurrent neural network model uses a latent short term memory (LSTM) unit or a gated recurrent unit (GRU) as a hidden layer unit.

5. The method of claim 1, wherein the grouping comprises grouping the plurality of sentences into one or more clusters based on a similarity between the sentence vectors for each of the plurality of sentences.

6. An apparatus for abstracting a sentence, the apparatus comprising:
an inputter configured to receive a plurality of sentences comprising natural language;
a sentence vector generator configured to generate a sentence vector for each of the plurality of sentences by using a recurrent neural network model;
a clusterer configured to group the plurality of sentences into one or more clusters by using the sentence vector; and
an ID generator configured to generate the same sentence identification (ID) for sentences grouped into the same cluster among the plurality of sentences.

7. The apparatus of claim 6, wherein the recurrent neural network model comprises a recurrent neural network model of an encoder-decoder structure comprising an encoder for generating a hidden state vector from an input sentence and a decoder for generating a sentence corresponding to the input sentence from the hidden state vector.

8. The apparatus of claim 7, wherein the sentence vector comprises a hidden state vector for each of a plurality of sentences generated by the encoder.

9. The apparatus of claim 7, wherein the recurrent neural network model uses a latent short term memory (LSTM) unit or a gated recurrent unit (GRU) as a hidden layer unit.

10. The apparatus of claim 6, wherein the clusterer is further configured to group the plurality of sentences into one or more clusters based on a similarity between the sentence vectors for each of the plurality of sentences.
